(19) United States
(12) Patent Application Publication
(10) Pub. No.: US 2014/0270883 A1
(43) Pub. Date: Sep. 18, 2014

(54) Stenographic Machine with Tilting Screen

(71) Applicant: Advantage Technology and Innovations, Inc., Stuart, FL (US)

(72) Inventor: Kent Lu, Taipei (TW)

(73) Assignee: Advantage Technology and Innovations, Inc., Stuart, FL (US)

(21) Appl. No.: 14/208,094

(22) Filed: Mar. 13, 2014

Related U.S. Application Data
(60) Provisional application No. 61/794,189, filed on Mar. 15, 2013.

(51) Int. Cl. B41J 3/26

(52) U.S. Cl. CPC B41J 3/26
USPC 400/94

(57) ABSTRACT

A stenographic machine includes a machine body and a display screen assembly. The machine body has a stenographic keyboard, a display connector, and a stenographic processor operatively connected to the stenographic keyboard and storing stenographic dictation by a stenographer. The display screen assembly has a back rest having a first end pivotally connected to the display connector and a second end. The display screen assembly has a screen body having a display operatively connected to the stenographic processor to display at least one of concurrent and previously stored stenographic dictation to a stenographer, having a screen face and a screen outer back surface, and is pivotally connected to the second end such that, when the display is pivoted downwards, the outer back surface faces upwards and, when the display pivoted upwards, the screen face faces a user and moves closer to the user as pivoting progresses.

### CROSS-REFERENCE TO RELATED APPLICATION

This application claims the priority, under 35 U.S.C. §119, of copending U.S. Provisional Patent Application No. 61/794,189, filed Mar. 15, 2013; the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present invention lies in the field of stenographic machines. The present disclosure relates to a tilting screen for a stenographic machine.

### BACKGROUND OF THE INVENTION

When a stenographer employs a stenographic machine in typical use, it is supported on a short tripod, monopod, or other supporting leg structure. In such a configuration, the stenographic machine can be placed in a comfortable position, e.g., between the thighs of the stenographer, without having to be supported on the stenographer's legs or without interfering with the stenographer's legs while sitting. While stenographers do typically take dictation near or adjacent a writing surface, such as a desk or table, stenographers desire to make written notes with the paper/notepad rested directly on top of the stenographic machine. Typical display screens on stenographic machines take up the top surface when folded down. If the display is on the top of the stenographic machine, this means that the stenographer will be pressing a writing utensil directly onto the surface of the display screen. Such pressure can and does cause serious harm to display. As a corollary, this means that a stenographer is unable to use the upper surface of the stenographic machine to write on without causing damage to the display screen.

The ProCAT Impression writer has a screen that can be closed without covering the stenographic keyboard. This screen, however, is similar to notebook computer screens. Because the screen is at the back of the writer, it is uncomfortably far away from the reporter, and difficult to see.

Thus, a need exists to overcome the problems with the prior art systems, designs, and processes as discussed above.

### SUMMARY OF THE INVENTION

The invention provides a tilting screen for a stenographic machine that overcomes the hereinafore-mentioned disadvantages of the heretofore-known devices and methods of this general type and that provide such features that, when closed, the screen virtually disappears into the machine. Thus, not only is the hideaway screen entirely protected from harm when in the stowed state/position, it is also aesthetically pleasing.

The angle of the screen assembly is adjustable as is the distance of the screen assembly to the user. The exemplary embodiment of the screen moves closer to the user when it is opened, making it easier to see and easier to reach.

In an exemplary embodiment, the tilting screen assembly slides in tracks on top of the stenographic/shorthand machine. There is a channel on each side of an upper screen tray in which the screen slides. These channels keep the screen in place and provide friction so that it does not tilt too easily when the screen is touched or the machine is jostled. In an exemplary embodiment, the display is a touch-screen.

With the foregoing and other objects in view, there is provided, in accordance with the invention, a screen assembly for a stenographic machine including a pivoting back rest having a proximal end and a distal end operable to pivot at the stenographic machine, and a pivoting screen assembly having a screen with a screen face and a screen outer back surface and pivotally connected to the proximal end such that, when pivoted screen downwards, the outer back surface faces upwards and, when pivoted screen upwards, the screen face faces a user and moves closer to the user as pivoting progresses.

With the objects of the invention in view, there is also provided a stenographic machine includes a machine body and a display screen assembly. The machine body has a stenographic keyboard, a display connector, and a stenographic processor operatively connected to the stenographic keyboard and storing stenographic dictation by a stenographer. The display screen assembly has a back rest having a first end pivotally connected to the display connector and a second end. The display screen assembly has a screen body having a display operatively connected to the stenographic processor to display at least one of concurrent and previously stored stenographic dictation to a stenographer, having a screen face and a screen outer back surface, and is pivotally connected to the second end such that, when the display is pivoted downwards, the outer back surface faces upwards and, when the display pivoted upwards, the screen face faces a user and moves closer to the user as pivoting progresses.

With the objects of the invention in view, there is also provided a display for a stenographic machine having a stenographic keyboard, a display connector, and a stenographic processor operatively connected to the stenographic keyboard and storing stenographic dictation by a stenographer, the display comprising a display screen assembly having a back rest having a first end to be pivotally connected to the display connector of the stenographic machine and a second end. A screen body of the display screen assembly has a display operatively connected to the stenographic processor when the first end is pivotally connected to the display connector, the display showing at least one of concurrent and previously stored stenographic dictation to a stenographer when so connected, has a screen face and a screen outer back surface, and, when pivotally connected to the second end, the outer back surface faces upwards when the display is pivoted downwards and the screen face faces a user and moves closer to the user as pivoting progresses when the display pivots upwards.

Although the invention is illustrated and described herein as embodied in a tilting screen for a stenographic machine, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a right side elevational view of an exemplary embodiment of a stenographic machine with a tilting screen in a stowed state;

FIG. 2 is a front elevational view of the stenographic machine of FIG. 1 with a tilting screen in a stowed state;

FIG. 3 is a front elevational view of the stenographic machine of FIG. 1 with the tilting screen in a partially tilted state;

FIG. 4 is a right side elevational view of the stenographic machine of FIG. 1 with the tilting screen in the partially tilted state;

FIG. 5 is a front elevational view of the stenographic machine of FIG. 1 with the tilting screen in a tilted state;

FIG. 6 is a right side elevational view of the stenographic machine of FIG. 1 with the tilting screen in the tilted state;

FIG. 7 is a side perspective view of an exemplary embodiment of a stenographic machine from above a right front corner with a tilting screen in a stowed state;

FIG. 8 is a side perspective view of the stenographic machine of FIG. 7 from above a left front corner with the tilting screen in a stowed state;

FIG. 9 is a side perspective view of the stenographic machine of FIG. 7 from above a right front corner with the tilting screen almost in a stowed state;

FIG. 10 is a side perspective view of the stenographic machine of FIG. 7 from above a right front corner with the tilting screen in a tilted state;

FIG. 11 is a side perspective view of the stenographic machine of FIG. 7 from above a right rear corner with the tilting screen in a partially tilted state;

FIG. 12 is a side perspective view of the stenographic machine of FIG. 10 from above a right front corner;

FIG. 13 is a side perspective view of the stenographic machine of FIG. 7 from above a right front corner with the tilting screen in a partially tilted state;

FIG. 14 is a side perspective view of the stenographic machine of FIG. 12 from a right front corner;

FIG. 15 is a top perspective view of another exemplary embodiment of a stenographic machine with a tilting screen in a stowed state;

FIG. 16 is a top perspective view of the stenographic machine of FIG. 15 from above a right side;

FIG. 17 is a side perspective view of the stenographic machine of FIG. 15 from the right side;

FIG. 18 is an enlarged fragmentary, top perspective view of the stenographic machine of FIG. 15 with the tilting screen in a partially tilted state;

FIG. 19 is a fragmentary, side perspective view of the stenographic machine of FIG. 15 from above a left side with the tilting screen in a partially tilted state;

FIG. 20 is an enlarged, fragmentary, side perspective view of the stenographic machine of FIG. 19 from above a right side;

FIG. 21 is an enlarged fragmentary, side perspective view of the stenographic machine of FIG. 19 with the tilting screen in a further partially tilted state;

FIG. 22 is a rear perspective view of the stenographic machine of FIG. 15 with the tilting screen in a partially tilted state;

FIG. 23 is an enlarged fragmentary, side perspective view of the stenographic machine of FIG. 15 from above a left rear corner with the tilting screen in a further partially tilted state;

FIG. 24 is an enlarged fragmentary, side perspective view of the stenographic machine of FIG. 15 with the tilting screen in a partially tilted state;

FIG. 25 is a side perspective view of the stenographic machine of FIG. 15 with the tilting screen in a further partially tilted state;

FIG. 26 is a fragmentary, side perspective view of the stenographic machine of FIG. 15 from above a front left corner with the tilting screen in a fully tilted state;

FIG. 27 is a fragmentary, side perspective view of the stenographic machine of FIG. 26 from above a front left corner with the tilting screen in a fully tilted state;

FIG. 28 is a perspective view of a further exemplary embodiment of a stenographic machine from above a front with a tilting back stop holding a tablet in a tilted state; and

FIG. 29 is a fragmentary, side perspective view of the stenographic machine of FIG. 28 from above a right side.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Described now are exemplary embodiments of the present invention. Referring now to the figures of the drawings in detail and first, particularly to FIGS. 1 to 6, there is shown a first exemplary embodiment of a stenographic machine 10 with a tilting and stowable screen assembly 20 configured as a hideaway screen. FIGS. 1 and 2 show the stenographic machine 10 with the screen assembly 20 in its stowed state. In this position, an outer surface 22 faces the user and has the display screen 24 hidden from view and, thereby, protected. The outer surface 22 is made of a material that protects the display screen 24 (which can be an LCD, LED, or other similar display) from harm if the stenographic machine 10, for example, is dropped or is used as a writing surface. In an exemplary embodiment, the outer surface 22 is made of the same material as the outer surface 12 of the stenographic machine 10. With such a configuration, the stowed display screen assembly 20 looks like the outside of the stenographic machine 10 and, therefore, is aesthetically pleasing.

FIGS. 3 and 4 show the stenographic machine 10 with the screen assembly 20 in an intermediate tilted state. As shown by arrow A in FIG. 4, the screen assembly 20 pivots to show a display leg 30 that secures the screen assembly 20 to the body of the stenographic machine 10. The display leg 30 pivots at a first end 32 that is attached to the body of the stenographic machine 10. The display leg 30 also pivots at an opposite second end 34, which is attached to the screen assembly 20. In particular, the second end 34 is pivotally connected to the outer surface 22 of screen assembly 20.

In this configuration, therefore, the display assembly 20 can rotate or pivot between the stowed position shown in FIGS. 1 and 2 and a fully tilted position, which is shown in FIGS. 5 and 6. The orientation of the screen assembly 20 shown in FIGS. 3 and 4, therefore, is only one of a continuous set of many intermediate tilting positions (arrow A) that the screen assembly 20 can be placed for various use angles and distances away from the stenographer. The display leg 30 can take the form of two opposing columnar-type legs that, when in the stowed position of the screen assembly 20, rest flat against the outer surface 22 inside hollows thereof so that the outer surface 36 of the display leg 30 smoothly aligns with the shape of the outer surface 22 of the screen assembly 20. In such a configuration, one or more of these display legs 30 also can be hollow to protect and contain all of the electrical conduits necessary to power and run the display screen 24. The display legs 30 can be telescoping, if desired, to move the screen assembly 20 closer to or further away from the stenographer during use.

Alternatively, the display leg 30 can take the form of a single panel that extends from the left side of the screen assembly 20 to the right. Such a configuration is depicted in the exemplary embodiment of the stenographic machine 100 shown in FIGS. 7 to 14. The stenographic machine 100 is like the stenographic machine 10. Accordingly, parts that are similar in the stenographic machine 100 are labeled with like numerals of stenographic machine 10 increased by 100.

This second exemplary embodiment of a stenographic machine 100 has a tilting and stowable screen assembly 120. FIGS. 7 and 8 show the stenographic machine 100 with the screen assembly 120 in its stowed state configured as a hideaway screen. In this position, an outer surface 122 of the screen assembly 120 faces the user and has the display screen 124 hidden from view and, thereby, protected. The outer surface 122 is made of a material that protects the display screen 124 (which can be an LCD, LED, or other similar display) from harm if the stenographic machine 100, for example, is dropped or is used as a writing surface. In the exemplary embodiment shown, the outer surface 122 is made of the same material as the outer surface 112 of the stenographic machine 100. The screen assembly 120 abuts a raised portion 114 of the stenographic machine 100 in this stowed position. With such a configuration, the stowed display screen assembly 120 looks like the outside of the stenographic machine 100 and, therefore, is aesthetically pleasing.

FIGS. 9 to 12 show the stenographic machine 100 with the screen assembly 120 in various intermediate tilted states. As shown by arrow A′ in FIG. 9, the screen assembly 120 pivots to show a display panel 130 that secures the screen assembly 120 to the body of the stenographic machine 100. As best shown in FIG. 11, the display panel 130 pivots at a first end 132 that is attached to the body of the stenographic machine 100. The display panel 130 also pivots at an opposite second end 134, which is attached to the screen assembly 120. In particular, the second end 134 is pivotally connected to a first end 125 of a cutout 126 within the outer surface 122 of screen assembly 120. In this configuration, therefore, the display assembly 120 can rotate or pivot between the stowed position shown in FIGS. 7 and 8 and a fully tilted position, which is shown in FIGS. 13 and 14. In the fully tilted position, the second end 127 of the cutout 126 is adjacent the raised portion 114 of the stenographic machine 100 after having been pivoted in the direction of arrow B′ to its fullest extent.

FIGS. 9 to 12 illustrate a few orientations of the screen assembly 120 that comprise a continuous set of many intermediate tilting positions in which the screen assembly 120 can be placed for various viewing angles and distances away from the stenographer.

The display panel 130 takes the form of a swing-out leg to enable the screen assembly 120 to stand upright on top of the stenographic machine 100. When first opening the screen assembly 120, the display panel 130 pivots about its first axis at the first end 132 (along the direction of arrow A′) and at the same time or thereafter also pivots about its second axis at the second end 134 (along the direction of arrow B′). Both pivots are shown in FIG. 10.

The display panel 130 also can be hollow to protect and contain all of the electrical conduits necessary to power and run the display screen 124. The display panel 130 can be telescoping, if desired, to move the screen assembly 120 closer to or further away from the stenographer during use.

As is shown in FIGS. 10 and 12, in particular, the lower end 128 of the screen assembly 120 (adjacent the second end 127) travels along a smooth surface 116 of the stenographic machine 100. This surface 116 allows the lower end 128 of the screen assembly 120 to be placed anywhere thereon to move anywhere between an upright, substantially transverse orientation (e.g., shown in FIG. 10) to a substantially flattened orientation (e.g., shown in FIG. 13). This allows the user to position the display screen 124 at virtually any viewing angle. The surface 116, however, need not be smooth. It can have indentations (e.g., periodic) that allow the user to place the display screen 124 at particular viewing angles. In such a case, the peaks between the indentations would have a height sufficient to damage the display screen 124 when in the stowed position (e.g., FIG. 7). The exemplary configuration has the lower end 128 of the screen assembly 120 not connected to the surface 116 or to the sides 118 surrounding the surface 116. In this configuration, therefore, the screen assembly 120 need not rest on the surface 116 at all. It can be supported above the surface 116 if there is sufficient friction at the first end 132 of the display panel 130. For example, the body of the first end 132 can have a first part of a ratcheting assembly and the connection area of the body of the stenographic machine 100 to the first end 132 can have a second part of the ratcheting assembly such that, when the display panel 130 is pivoted upwards, the weight of the entire display panel 130 and the screen assembly 120 is supported and remains suspended above the surface 116.

Alternatively, the screen assembly can be connected to the top surface of the stenographic machine. Various connective embodiments for the screen assembly include tongue-and-groove, slot-and-pin, and sled-and-track, to name a few. A sled-and-track configuration is depicted in the exemplary embodiment of the stenographic machine 200 shown in FIGS. 15 to 27. The stenographic machine 200 is like the stenographic machine 10 and the stenographic machine 100. Accordingly, parts that are similar in the stenographic machine 200 are labeled with like numerals of stenographic machine 10 and/or stenographic machine 100 but increased by 200 or 100, respectively.

The stenographic machine 200 shown in FIGS. 15 to 27 illustrates a sled-and-track connection 240. This third exemplary embodiment of a stenographic machine 200 has a tilting and stowable screen assembly 220 configured as a hideaway screen. FIGS. 15 to 17 show the stenographic machine 200 with the screen assembly 220 in its stowed state. In this position, an outer surface 222 of the screen assembly 220 faces the user and has the display screen 224 hidden from view and, thereby, protected. The outer surface 222 is made of a material that protects the display screen 224 (which can be an LCD, LED, or other similar display) from harm if the stenographic machine 200, for example, is dropped or is used as a writing surface. In the exemplary embodiment shown, the outer surface 222 is made of the same material as the outer surface 212 of the stenographic machine 200. The screen assembly 220 abuts a raised portion 214 of the stenographic machine 200 in this stowed position. With such a configuration, the stowed display screen assembly 220 looks like the outside of the stenographic machine 200 and, therefore, is aesthetically pleasing. To open the screen assembly 220 from this locked-down position, a release device 215, for example, in the form of a button shown in FIG. 16, is pressed by the user.

FIGS. 18 to 27 show the stenographic machine 200 with the screen assembly 220 in various intermediate tilted states. As shown by arrow A′ in FIGS. 20 and 21, the screen assembly 220 pivots to show a display panel 230 that secures the screen assembly 220 to the body of the stenographic machine 200. As best shown in FIG. 20, the display panel 230 pivots at a first end 232 that is attached to the body of the stenographic machine 200. The display panel 230 also pivots at an opposite second end 234, which is attached to the screen assembly 220. In particular, the second end 234 is pivotally connected to a first end 225 of a cutout 226 within the outer surface 222 of the screen assembly 220. In this configuration, therefore, the display assembly 220 can rotate or pivot between the stowed position shown in FIGS. 15 and 16 and a fully tilted position, which is shown in FIGS. 26 and 27. In the fully tilted position, the second end 227 of the cutout 226 is adjacent the raised portion 214 of the stenographic machine 200 after having been pivoted in the direction of arrow B′ to its fullest extent.

FIGS. 18 to 25 illustrate a few orientations of the screen assembly 220 that comprise a continuous set of many intermediate tilting positions in which the screen assembly 220 can be placed for various viewing angles and distances away from the stenographer.

The display panel 230 takes the form of a swing-out leg to enable the screen assembly 220 to stand upright on top of the stenographic machine 200. When first opening the screen assembly 220, the display panel 230 pivots about its first axis at the first end 232 (along the direction of arrow A′) and at the same time or thereafter also pivots about its second axis at the second end 134 (along the direction of arrow B′). Both pivots are shown in FIG. 20.

The display panel 230 also can be hollow to protect and contain all of the electrical conduits necessary to power and run the display screen 224. The display panel 230 can be telescoping, if desired, to move the screen assembly 220 closer to or further away from the stenographer during use.

As is shown in FIGS. 18 to 21 and FIGS. 23 to 25, the lower end 228 of the screen assembly 220 (adjacent the second end 227) travels along a smooth surface 216 of the stenographic machine 200. In contrast to the stenographic machine 100, however, the surface 216 has or forms one or more guide tracks 217 shaped to receive therein a respective sled 250, which is best shown in FIGS. 23 and 24. Each sled 250 is pivotally attached to the lower end 228 of the screen assembly 220 aligned to extend into and slide within the respective guide track 217 (although the sled can be merely an extension of the screen assembly 220 or it can be a boss with, for example, a rounded bottom). As such, when the stenographer opens and tilts the screen assembly 220 to an upright open position, the sled 250 slides though the track 217 from the rear end of the track 217 towards the front end of the track 217 adjacent the raised portion 214. In an alternative, opposite configuration, an upward-extending boss at the surface 216 can be a guide that inserts within a groove in the lower end 228 of the screen assembly 220 to perform an equivalent function of guiding the lower end 228 of the screen assembly 220.

The track(s) 217 and the sled(s) 250 allow the lower end 228 of the screen assembly 220 to be placed anywhere on the surface 216 between the stowed orientation (e.g., shown in FIG. 15), an upright, substantially transverse orientation (e.g., shown in FIG. 19 or 20) to a substantially flattened orientation (e.g., shown in FIG. 26 or 27). This allows the user to position the display screen 224 at virtually any viewing angle. It is beneficial if the track 217 is coated with a smooth material, such as Polytetrafluoroethylene (PTFE), and/or if the sled 250 is made from a similar “slip stick” material, such as PTFE (e.g., TEFLON®) or RULON®. With such attributes, the sled 250 can slide within the track 217 but also stick therein and remain in a set position when sliding by the user ceases. Smooth movement also is desirable as a feature for aesthetic reasons. In this configuration with a rectangular track 217 and a correspondingly shaped sled 250, the sled 250 can be lifted out of and above the track 217 if desired.

The track 217 need not be shaped as a rectangle as shown to fit a correspondingly shaped sled 250, however. Alternatively, one or more of the interior sides of the track 217 can have an undercut or a dovetail cut to receive therein a respectively counter-shaped sled 250. In such configurations, in contrast, after installation at the manufacturer, the sled 250 will not be able to be moved out from the track 217.

Finally, if the first connection between the lower end 132, 232 of the display panel 130, 230 and the body of the stenographic machine 100, 200 is made much narrower than shown and is duplicated such that there are two pivoting connection between the display panel 130, 230 and the body, one pivot being transverse to the other, then the display panel 130, 230, will be able to rotate the entire screen assembly 120, 220 from its wide-and-short configuration shown in FIGS. 1 to 27 to a non-illustrated narrow-and-tall configuration. Such a connector is found in laptops that are able to convert to tablets—where the screen is first opened ninety degrees upwards and, then, the entire screen is rotated about a vertical axis 180 degrees and then folded back down to create the tablet.

Taking this dual-articulating step even further, the display assembly 20, 120, 220 can be entirely removed and replaced by a flat, panel back rest 320 that only moves like the display assembly 20, 120, 220 in any of the above-mentioned configurations, but it has no active display. Equipping the stenographic machine 10, 100, 200 with a wireless connection device 310, such as Bluetooth (shown diagrammatically with dashed lines) allows an alternative configuration that permits a standard tablet 300 (such as an iPad) to be used as the display itself. This alternative configuration is shown, diagrammatically, in FIGS. 28 and 29. In these figures, the display assembly 20, 120, 220 is shown but is intended to depict the back rest panel 320 on which leans the tablet 300 in use. Here, the tablet 300 provides all display functionality of the stenographic machine 10, 100, 200. In this way, the stenographic machine 10, 100, 200 can do away with the technologically complex and expensive display assembly 20, 120, 220, typically requiring updates and warranty.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A screen assembly for a stenographic machine, comprising:
a pivoting back rest having:
a proximal end; and
a distal end operable to pivot at the stenographic machine; and
a pivoting screen assembly:
having a screen with a screen face and a screen outer back surface; and
pivotally connected to the proximal end such that, when pivoted screen downwards, the outer back surface faces upwards and, when pivoted screen upwards, the screen face faces a user and moves closer to the user as pivoting progresses.

2. A stenographic machine, comprising:
a machine body having:
a stenographic keyboard;
a display connector; and
a stenographic processor operatively connected to the stenographic keyboard and storing stenographic dictation by a stenographer;
a display screen assembly having:
a back rest having:
a first end pivotally connected to the display connector; and
a second end; and
a screen body:
having a display operatively connected to the stenographic processor to display at least one of concurrent and previously stored stenographic dictation to a stenographer;
having a screen face and a screen outer back surface; and
pivotally connected to the second end such that, when the display is pivoted downwards, the outer back surface faces upwards and, when the display pivoted upwards, the screen face faces a user and moves closer to the user as pivoting progresses.

3. A display for a stenographic machine having a stenographic keyboard, a display connector, and a stenographic processor operatively connected to the stenographic keyboard and storing stenographic dictation by a stenographer, the display comprising:
a display screen assembly having:
a back rest having:
a first end to be pivotally connected to the display connector of the stenographic machine; and
a second end; and
a screen body:
having a display operatively connected to the stenographic processor when the first end is pivotally connected to the display connector, the display showing at least one of concurrent and previously stored stenographic dictation to a stenographer when so connected;
having a screen face and a screen outer back surface; and
when pivotally connected to the second end:
the outer back surface faces upwards when the display is pivoted downwards; and
the screen face faces a user and moves closer to the user as pivoting progresses when the display pivots upwards.
